(19) United States
(12) Patent Application Publication
(10) Pub. No.: US 2026/0294705 A1
(43) Pub. Date: Oct. 1, 2026

(54) TRANSFER SYSTEM FOR A LAVATORY WITHIN AN INTERNAL CABIN OF A VEHICLE

(71) Applicant: THE BOEING COMPANY, Arlington, VA (US)

(72) Inventor: Anthony Earl Anderson, Snohomish, WA (US)

(73) Assignee: THE BOEING COMPANY, Arlington, VA (US)

(21) Appl. No.: 19/428,509

(22) Filed: Dec. 22, 2025

Related U.S. Application Data
(60) Provisional application No. 63/779,446, filed on Mar. 28, 2025.

(51) Int. Cl. A61G 5/10; A61G 7/10; B64D 11/02

(52) U.S. Cl. CPC A61G 5/1002; A61G 7/1005; A61G 7/1015; A61G 7/1051; A61G 7/1076; B64D 11/02; A61G 2220/10

(57) ABSTRACT

A lavatory is configured to be disposed within an internal cabin of a vehicle. The lavatory includes a base floor, one or more walls extending from the base floor, and a ceiling connected to the one or more walls. An internal chamber is defined between the base floor, the one or more walls, and the ceiling. A toilet is within the internal chamber. A transfer system is within the internal chamber. The transfer system is configured to be used to move an individual between a wheelchair and the toilet. The transfer system includes a pivot coupling secured to one or both of the one or more walls or the ceiling of the lavatory. A hoist is connected to the pivot coupling. The hoist is configured to move between a stowed position and a deployed position. A harness is secured to the hoist.

### CROSS-REFERENCE TO RELATED APPLICATION

This application relates to and claims priority benefits from U.S. Provisional Patent Application No. 63/779,446, filed Mar. 28, 2025, which is hereby incorporated by reference in its entirety.

### FIELD OF THE DISCLOSURE

Examples of the present disclosure generally relate to a transfer system for a lavatory within an internal cabin of a vehicle.

### BACKGROUND OF THE DISCLOSURE

Commercial aircraft are used to transport passengers between various locations. A typical commercial aircraft includes one or more lavatories within an internal cabin.

A recent regulation issued by the United States Department of Transportation requires lavatories onboard commercial aircraft to be sized to accommodate a dependent transfer by a 95th percentile-sized assistant of a 95th percentile-sized wheelchair user from an on-board wheelchair to a toilet.

However, an assistant may be susceptible to injury while manually transferring another individual from a wheelchair to a toilet within a lavatory.

### SUMMARY OF THE DISCLOSURE

A need exists for a system and a method for safely, efficiently, and effectively transferring an individual between a wheelchair and a toilet within a lavatory of a commercial aircraft.

With that need in mind, certain examples of the present disclosure provide a lavatory configured to be disposed within an internal cabin of a vehicle. The lavatory includes a base floor, one or more walls extending from the base floor, and a ceiling connected to the one or more walls. An internal chamber is defined between the base floor, the one or more walls, and the ceiling. A toilet is within the internal chamber. A transfer system is also within the internal chamber. The transfer system configured to be used to move an individual between a wheelchair and the toilet. The transfer system includes a pivot coupling secured to one or both of the one or more walls or the ceiling of the lavatory. A hoist is connected to the pivot coupling. The hoist is configured to move between a stowed position (such as against the one or more walls) and a deployed position. A harness is secured to the hoist.

In at least one example, the transfer system further includes one or more actuators coupled to one or both of the pivot coupling or the hoist. The pivot coupling can be secured to the one or more walls or the ceiling through one or more fasteners.

In at least one example, the hoist includes an arm secured to the pivot coupling. The arm includes a first end secured to the pivot coupling, and a second end distally located from the first end. As a further example, a cross-bar is secured to the second end of the arm. The cross-bar retains the harness. As a further example, an extension chain hangs from the second end of the arm. The cross-bar couples to the extension chain. The harness hangs from the cross-bar. The cross-bar can be removable from the extension chain, and the harness can be removable from the cross-bar. In at least one example, the arm is configured to rotate between different positions. The arm can include a manual ratchet configured to prevent the arm from rotating to one or more positions.

Certain examples of the present disclosure provide a vehicle including an internal cabin, and a lavatory disposed within the internal cabin. The lavatory includes that transfer system, as described herein.

Certain examples of the present disclosure provide a method including disposing a transfer system within the internal chamber. Said disposing includes securing a pivot coupling to one or both of the one or more walls or the ceiling of the lavatory; connecting a hoist to the pivot coupling, wherein the hoist is configured to move between a stowed position and a deployed position; and securing a harness to the hoist.

### BRIEF DESCRIPTION OF THE DRAWINGS

FIG. 1 illustrates a perspective front view of an aircraft, according to an example of the present disclosure.

FIG. 2 illustrates a perspective internal view of a lavatory, according to an example of the present disclosure.

FIG. 3 illustrates a top view of a transfer system within a lavatory, according to an example of the present disclosure.

FIG. 4 illustrates a front view of a harness, according to an example of the present disclosure.

FIG. 5 illustrates a rear view of the harness.

FIG. 6 illustrates a front view of an individual within the harness.

FIG. 7 illustrates a rear view of the individual within the harness.

FIG. 8 illustrates an isometric exploded view of a transfer system, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Examples of the present disclosure provide a transfer system for a lavatory within an internal cabin of a vehicle, such as a commercial aircraft. The transfer system is configured to facilitate transfer of an individual within the lavatory from a wheelchair to a toilet without the need for another individual to manually lift and transfer the individual.

Certain examples of the present disclosure provide a vehicle including an internal cabin. A lavatory is within the internal cabin. The lavatory includes a toilet. A transfer system is within the lavatory. The transfer system is configured to be used to move an individual between a wheelchair and the toilet. In at least one example, the transfer system includes a pivot coupling secured to one or both of a wall or a ceiling of the lavatory. A hoist is connected to the pivot coupling. A harness is secured to the hoist. The hoist is configured to move between a stowed position and a deployed position. The transfer system can also include one or more actuators coupled to one or both of the pivot coupling or the hoist

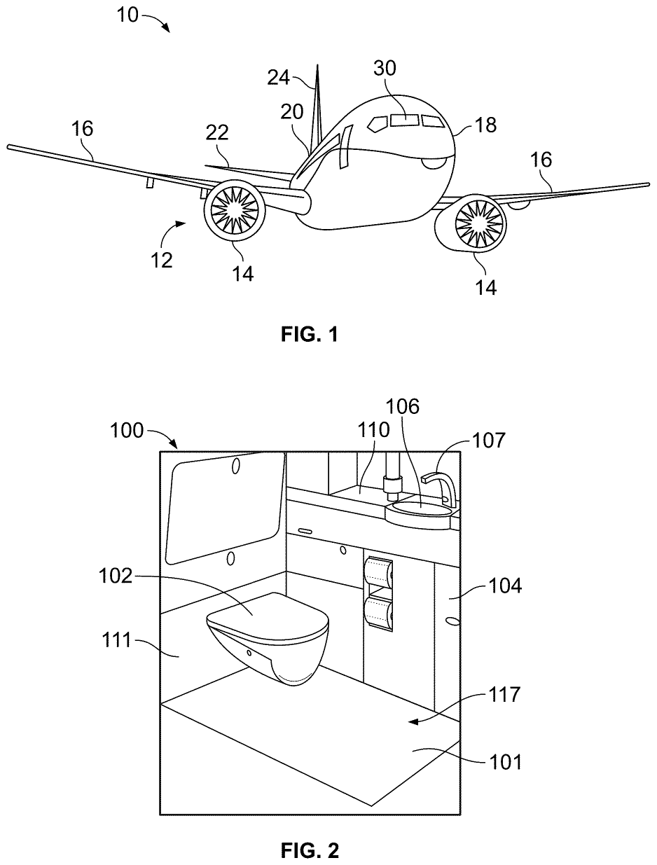

FIG. 1 illustrates a perspective front view of an aircraft 10, according to an example of the present disclosure. The aircraft 10 includes a propulsion system 12 that includes engines 14, for example. Optionally, the propulsion system 12 may include more engines 14 than shown. The engines 14 are carried by wings 16 of the aircraft 10. In other examples, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin 30, which includes a flight deck or cockpit, one or more work sections (for example, galleys, personnel carry-on baggage areas, and the like), one or more passenger sections (for example, first class, business class, and coach sections), one or more lavatories, and/or the like. Optionally, instead of an aircraft, examples of the present disclosure may be used with various other vehicles, such as automobiles, buses, locomotives and train cars, watercraft, and the like. Further, examples of the present disclosure may be used with respect to fixed structures, such as commercial and residential buildings.

FIG. 2 illustrates a perspective internal view of a lavatory 100, according to an example of the present disclosure. The lavatory 100 may be onboard an aircraft, as described above. Optionally, the lavatory 100 may be onboard various other vehicles. In other examples, the lavatory 100 may be within a fixed structure, such as a commercial or residential building. The lavatory 100 includes a base floor 101 that supports a toilet 102, cabinets 104, and a sink 106 or wash basin. A faucet 107 is configured to flow water into the sink 106. The faucet 107 is in fluid communication with a water supply, such as through one or more conduits, pipes, tubes, and/or the like. The sink 106 is disposed on and/or within a countertop 110, which is disposed on or otherwise over a cabinet 104. The lavatory 100 may be arranged differently than shown. The lavatory 100 may include more or fewer components than shown.

The lavatory 100 provides an internal chamber defined between the base floor 101, walls 111 extending from the floor 101, and the ceiling connected to the walls 111. The toilet 102 and other components are within the internal chamber 117, as shown. As described herein, a transfer system is also within the internal chamber. The transfer system is configured to be used to move an individual between a wheelchair and the toilet 102.

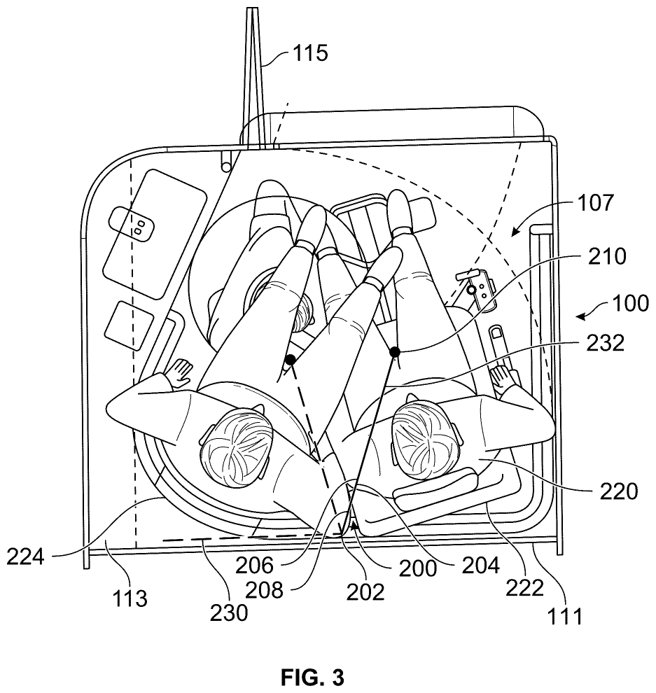

FIG. 3 illustrates a top view of a transfer system 200 within a lavatory 100, according to an example of the present disclosure. The transfer system 200 includes a pivot coupling 202 secured to a wall 111 and/or a ceiling 113 within the lavatory 100. The lavatory 100 also includes a door 115 configured to be selectively moved between an open position (as shown in FIG. 3) and a closed position. In the open position, an individual can enter and exit an internal chamber 117 of the lavatory 100.

The pivot coupling 202 can include a bracket secured to the wall 111 and/or the ceiling 113, such as through one more fasteners, adhesives, and/or the like. One or more pivot bearings are secured within the bracket, for example.

A hoist 204 is secured to the pivot coupling 202. The hoist 204 includes an arm 206, which is secured to the pivot coupling 202, such as to the pivot bearing(s). The arm 206 includes a first end 208 secured to the pivot coupling 202, and a second end 210, which is distally located from the first end 208. The second end 210 of the arm 206 is configured to retain a cross-bar, which is configured to securely retain a harness.

The arm 206 of the hoist 204 is configured to rotate between different positions. The arm 206 can include a manual ratchet to prevent the arm 206 from rotating to an undesired position.

In operation, an individual 220 is positioned within the harness. The arm 206 is moved from a stowed position 230, such as against the wall 111, to a deployed position 232. As the arm 206 of the hoist 204 moves, the individual moves along therewith. In this manner, the transfer system 200 is able to move the individual 220 between a wheelchair 222 and a toilet 224, for example. As another example, the stowed position 230 can be within a recessed channel formed within the wall 111. As another example, the stowed position 230 can be against a lower surface of the ceiling 113. As another example, the stowed position 230 can be within a recessed channel formed within the ceiling 113.

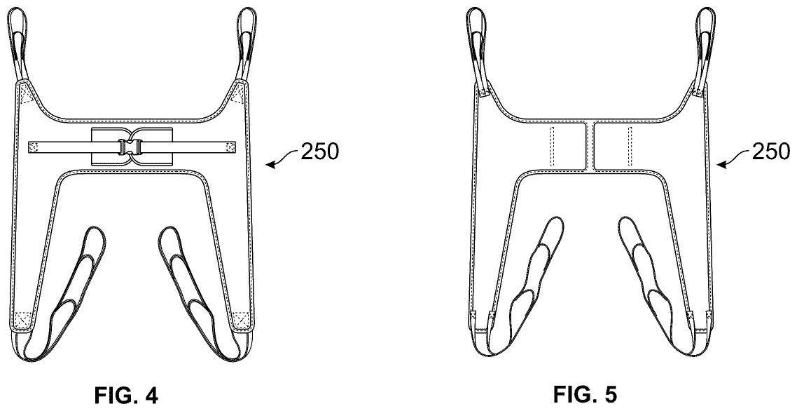

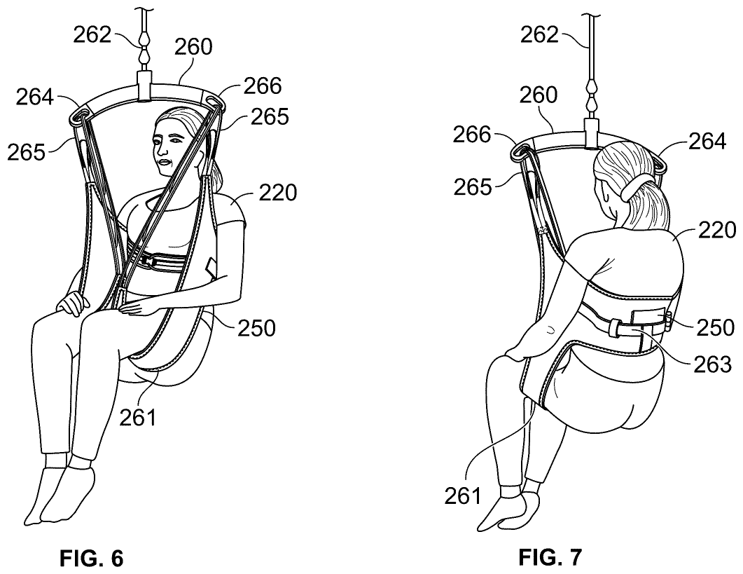

FIG. 4 illustrates a front view of a harness 250, according to an example of the present disclosure. FIG. 5 illustrates a rear view of the harness 250. FIG. 6 illustrates a front view of an individual 220 within the harness 250. FIG. 7 illustrates a rear view of the individual 220 within the harness 250.

Referring to FIGS. 3-7, the second end 210 of the arm 206 is configured to retain the cross-bar 260, on which the harness 250 hangs. In at least one example, an extension chain 262 hangs from the second end 210. The extension chain 262 couples to the cross-bar 260. The cross-bar 260 can be removable from the extension chain 262. Further, the harness 250 can be removable from the cross-bar 260.

In at least one example, the harness 250 includes a lower support strap 261 connected to a back support 263. The lower support strap 261 is configured to be positioned underneath, and support upper portions of legs of an individual, while the back support 263 fits around and support a back of the individual. Suspension straps 265 extend from one or both of the lower support strap 261 and/or the back support 263 and are configured to removably connect to opposite ends 264 and 266 of the cross-bar 260. Optionally, the harness 250 can be sized, shaped, and configured differently than shown.

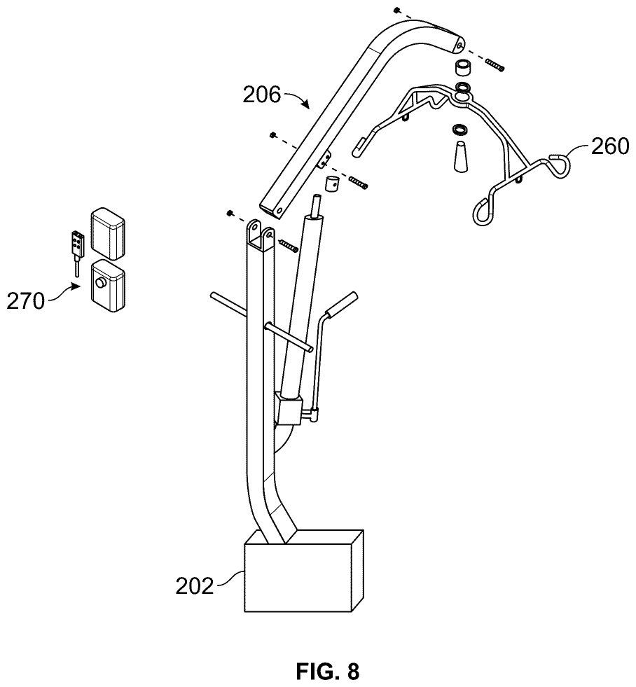

FIG. 8 illustrates an isometric exploded view of a transfer system 200, according to an example of the present disclosure. The hoist 204 can include one or more arms, components, and/or the like. In at least one example, one or more actuators 270, such as motors, are coupled to one or both of the pivot coupling 202 and/or the hoist 204 to provide automatic, powered movement. Optionally, the transfer system 200 may not include an actuator.

The transfer system 200 shown in FIG. 8 is merely exemplary. The transfer system 200 can include more, fewer, or different components than shown.

Referring to FIGS. 1-8, the transfer system 200 is disposed within the lavatory 100, and is configured to easily transfer an individual between an on-board wheelchair and a toilet. The harness 250 can be or otherwise include a sling, which the individual can readily wear and remove. The hoist 204 is moved into the stowed position, when not in use. The transfer system 200 can distribute load through the wall 111 and/or the ceiling 113 of the lavatory 100.

The transfer system 200 can be powered. In at least one example, the transfer system 200 can be movably coupled to one or more rails, such as secured to a ceiling.

The transfer system 200 is configured to be disposed within the lavatory 100 of an internal cabin of a vehicle. As can be appreciated, the space within a lavatory of a vehicle is constrained. For example, a lavatory within a commercial aircraft is sized and shaped to be useful and comfortable, while at the same time having a reduced size and shape so that passenger seating capacity within the internal cabin is not otherwise reduced. The design and engineering considerations with respect to the size, shape, and overall footprint of lavatory of a commercial aircraft are significantly stricter as compared to various commercial, residential, and municipal buildings, in which size, space, and footprint are not such limiting factors. The transfer system 200 is configured with such considerations in mind. In particular, the transfer system 200 is specifically configured for use within the tight confines of a lavatory within an internal cabin of a vehicle, such as a commercial aircraft.

Additionally, a lavatory of a commercial aircraft is typically not large enough to allow for a mobile transfer hoist to be maneuvered therein. For example, a threshold that allows access into and out of the lavatory is typically not large enough to allow for a bulky mobile transfer structure. Moreover, such a mobile structure would also occupy space within the internal cabin when not in use, which would therefore require an additional stowage area, thereby preventing such space from being used for other purposes. Accordingly, integrating the transfer system 200 directly into the lavatory 100 of the aircraft allows for effective and efficient transfer of without the need for separate transfer systems which typically cannot be maneuvered into and out of the tight confines of the lavatory 100.

Further, the disclosure comprises embodiments according to the following clauses:

Clause 1. A lavatory configured to be disposed within an internal cabin of a vehicle, the lavatory comprising:
a base floor;
one or more walls extending from the base floor;
a ceiling connected to the one or more walls, wherein an internal chamber is defined between the base floor, the one or more walls, and the ceiling;
a toilet within the internal chamber; and
a transfer system within the internal chamber, the transfer system configured to be used to move an individual between a wheelchair and the toilet, wherein the transfer system comprises:
   a pivot coupling secured to one or both of the one or more walls or the ceiling of the lavatory;
   a hoist connected to the pivot coupling, wherein the hoist is configured to move between a stowed position and a deployed position; and
   a harness secured to the hoist.

Clause 2. The lavatory of Clause 1, wherein the transfer system further comprises one or more actuators coupled to one or both of the pivot coupling or the hoist.

Clause 3. The lavatory of Clauses 1 or 2, wherein the pivot coupling is secured to the one or more walls or the ceiling through one or more fasteners.

Clause 4. The lavatory of any of Clauses 1-3, wherein the hoist comprises an arm secured to the pivot coupling, wherein the arm comprises:
a first end secured to the pivot coupling; and
a second end distally located from the first end.

Clause 5. The lavatory of Clause 4, further comprising a cross-bar secured to the second end of the arm, wherein the cross-bar retains the harness.

Clause 6. The lavatory of Clause 5, further comprising an extension chain that hangs from the second end of the arm, wherein the cross-bar couples to the extension chain, and wherein the harness hangs from the cross-bar.

Clause 7. The lavatory of Clause 6, wherein the cross-bar is removable from the extension chain, and wherein the harness is removable from the cross-bar.

Clause 8. The lavatory of any of Clauses 4-7, wherein the arm is configured to rotate between different positions.

Clause 9. The lavatory of Clause 8, wherein the arm includes a manual ratchet configured to prevent the arm from rotating to one or more positions.

Clause 10. The lavatory of any of Clauses 1-9, wherein the stowed position is against the one or more walls.

Clause 11. A vehicle comprising:
an internal cabin; and
a lavatory disposed within the internal cabin, the lavatory comprising:
   a base floor;
   one or more walls extending from the base floor;
   a ceiling connected to the one or more walls, wherein an internal chamber is defined between the base floor, the one or more walls, and the ceiling;
   a toilet within the internal chamber; and
   a transfer system within the internal chamber, the transfer system configured to be used to move an individual between a wheelchair and the toilet, wherein the transfer system comprises:
      a pivot coupling secured to one or both of the one or more walls or the ceiling of the lavatory;
      a hoist connected to the pivot coupling, wherein the hoist is configured to move between a stowed position and a deployed position; and
      a harness secured to the hoist.

Clause 12. The vehicle of Clause 11, wherein the transfer system further comprises one or more actuators coupled to one or both of the pivot coupling or the hoist.

Clause 13. The vehicle of Clauses 11 or 12, wherein the pivot coupling is secured to the one or more walls or the ceiling through one or more fasteners.

Clause 14. The vehicle of any of Clauses 11-13, wherein the hoist comprises an arm secured to the pivot coupling, wherein the arm comprises:
a first end secured to the pivot coupling; and
a second end distally located from the first end.

Clause 15. The vehicle of any of Clauses 11-14, further comprising a cross-bar secured to the second end of the arm, wherein the cross-bar retains the harness.

Clause 16. The vehicle of Clause 15, further comprising an extension chain that hangs from the second end of the arm, wherein the cross-bar couples to the extension chain, and wherein the harness hangs from the cross-bar.

Clause 17. The vehicle of Clause 16, wherein the cross-bar is removable from the extension chain, and wherein the harness is removable from the cross-bar.

Clause 18. The vehicle of any of Clauses 14-17, wherein the arm is configured to rotate between different positions, and wherein the arm includes a manual ratchet configured to prevent the arm from rotating to one or more positions.

Clause 19. The vehicle of any of Clauses 11-18, wherein the stowed position is against the one or more walls.

Clause 20. A method for a lavatory disposed within an internal cabin of a vehicle, the lavatory comprising:
a base floor;
one or more walls extending from the base floor;
a ceiling connected to the one or more walls, wherein an internal chamber is defined between the base floor, the one or more walls, and the ceiling;
a toilet within the internal chamber,
the method comprising:
disposing a transfer system within the internal chamber, the transfer system configured to be used to move an individual between a wheelchair and the toilet, wherein said disposing comprises:
securing a pivot coupling to one or both of the one or more walls or the ceiling of the lavatory;
connecting a hoist to the pivot coupling, wherein the hoist is configured to move between a stowed position and a deployed position; and
securing a harness to the hoist.

As described herein, examples of the present disclosure provide a system and a method for safely, efficiently, and effectively transferring an individual between a wheelchair and a toilet within a lavatory of a commercial aircraft.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A lavatory configured to be disposed within an internal cabin of a vehicle, the lavatory comprising:
a base floor;
one or more walls extending from the base floor;
a ceiling connected to the one or more walls, wherein an internal chamber is defined between the base floor, the one or more walls, and the ceiling;
a toilet within the internal chamber; and
a transfer system within the internal chamber, the transfer system configured to be used to move an individual between a wheelchair and the toilet, wherein the transfer system comprises:
a pivot coupling secured to one or both of the one or more walls or the ceiling of the lavatory;
a hoist connected to the pivot coupling, wherein the hoist is configured to move between a stowed position and a deployed position; and
a harness secured to the hoist.

2. The lavatory of claim 1, wherein the transfer system further comprises one or more actuators coupled to one or both of the pivot coupling or the hoist.

3. The lavatory of claim 1, wherein the pivot coupling is secured to the one or more walls or the ceiling through one or more fasteners.

4. The lavatory of claim 1, wherein the hoist comprises an arm secured to the pivot coupling, wherein the arm comprises:
a first end secured to the pivot coupling; and
a second end distally located from the first end.

5. The lavatory of claim 4, further comprising a cross-bar secured to the second end of the arm, wherein the cross-bar retains the harness.

6. The lavatory of claim 5, further comprising an extension chain that hangs from the second end of the arm, wherein the cross-bar couples to the extension chain, and wherein the harness hangs from the cross-bar.

7. The lavatory of claim 6, wherein the cross-bar is removable from the extension chain, and wherein the harness is removable from the cross-bar.

8. The lavatory of claim 4, wherein the arm is configured to rotate between different positions.

9. The lavatory of claim 8, wherein the arm includes a manual ratchet configured to prevent the arm from rotating to one or more positions.

10. The lavatory of claim 1, wherein the stowed position is against the one or more walls.

11. A vehicle comprising:
an internal cabin; and
a lavatory disposed within the internal cabin, the lavatory comprising:
a base floor;
one or more walls extending from the base floor;
a ceiling connected to the one or more walls, wherein an internal chamber is defined between the base floor, the one or more walls, and the ceiling;
a toilet within the internal chamber; and
a transfer system within the internal chamber, the transfer system configured to be used to move an individual between a wheelchair and the toilet, wherein the transfer system comprises:
a pivot coupling secured to one or both of the one or more walls or the ceiling of the lavatory;
a hoist connected to the pivot coupling, wherein the hoist is configured to move between a stowed position and a deployed position; and
a harness secured to the hoist.

12. The vehicle of claim 11, wherein the transfer system further comprises one or more actuators coupled to one or both of the pivot coupling or the hoist.

13. The vehicle of claim 11, wherein the pivot coupling is secured to the one or more walls or the ceiling through one or more fasteners.

14. The vehicle of claim 11, wherein the hoist comprises an arm secured to the pivot coupling, wherein the arm comprises:
a first end secured to the pivot coupling; and
a second end distally located from the first end.

15. The vehicle of claim 11, further comprising a cross-bar secured to the second end of the arm, wherein the cross-bar retains the harness.

16. The vehicle of claim 15, further comprising an extension chain that hangs from the second end of the arm, wherein the cross-bar couples to the extension chain, and wherein the harness hangs from the cross-bar.

17. The vehicle of claim 16, wherein the cross-bar is removable from the extension chain, and wherein the harness is removable from the cross-bar.

18. The vehicle of claim 14, wherein the arm is configured to rotate between different positions, and wherein the arm includes a manual ratchet configured to prevent the arm from rotating to one or more positions.

19. The vehicle of claim 11, wherein the stowed position is against the one or more walls.

20. A method for a lavatory disposed within an internal cabin of a vehicle, the lavatory comprising:
a base floor;
one or more walls extending from the base floor;
a ceiling connected to the one or more walls, wherein an internal chamber is defined between the base floor, the one or more walls, and the ceiling; and
a toilet within the internal chamber,
the method comprising:
disposing a transfer system within the internal chamber, the transfer system configured to be used to move an individual between a wheelchair and the toilet, wherein said disposing comprises:
securing a pivot coupling to one or both of the one or more walls or the ceiling of the lavatory;
connecting a hoist to the pivot coupling, wherein the hoist is configured to move between a stowed position and a deployed position; and
securing a harness to the hoist.
